(19) United States
(12) Patent Application Publication
(10) Pub. No.: US 2004/0205969 A1
(43) Pub. Date: Oct. 21, 2004

(54) System of two types of shaving apparatus

(76) Inventors: Sjoerd Haites, Drachten (NL); Hendrik Poel, Drachten (NL); Mattheus Jacobus Van Der Meer, Drachten (NL)

Correspondence Address: US Philips Corporation, Intellectual Property Department, PO Box 3001, Briarcliff Manor, NY, 10510, US

(21) Appl. No.: 10/487,208

(22) PCT Filed: Aug. 19, 2002
(86) PCT No.: PCT/IB02/03357

(30) Foreign Application Priority Data
Aug. 23, 2001 (EP) 01203168.8

(51) Int. Cl. B26B 19/14

(52) U.S. Cl. 30/43.6

(57) ABSTRACT

System of two types of shaving apparatus, each having a housing (1) on which a holder (2) for at least one cutting unit (3) can be mounted, which cutting unit comprises an external cutting element (4) and an internal cutting element (5) rotatably driven relative to the external cutting element, which cutting unit (3) can be detachably mounted in an opening (8) of the holder (2). The external cutting element (4) of only one of the two types of shaving apparatus is provided with at least one recess (11), and the holder (2) of the type of shaving apparatus in question is provided with at least one cam (12) which corresponds to the recess (11) of the external cutting element (4).

The invention relates to a system of two types of shaving apparatus, each having a housing on which a holder for at least one cutting unit can be mounted, which cutting unit comprises an external cutting element, which is formed by a circular cover provided with hair entry apertures, and an internal cutting element comprising hair cutting means, which is rotatably driven relative to the external cutting element, which holder is provided with an opening in which the cutting unit can be detachably fitted.

Generally speaking, a manufacturer of shaving apparatuses will keep putting new types of shaving apparatus on the market through the years, which new types feature improvements in comparison with previous types. A large number of components for various types of shaving apparatus will remain unchanged for a large number of years, however, for example as regards the dimensions and the functionality thereof, because they are quite satisfactory. Said components include inter alia the shaving head holder comprising one or more cutting units, also referred to as shaving heads. Thus, the main dimensions of the cutting unit, such as the diameter of the external cutting element and the related dimensions of the internal cutting element, will remain the same for many types. With shaving apparatuses of the kind referred to in the first paragraph, the cutting unit can be removed from the holder, because use will lead to wear on the cutting elements in the course of time, such that the apparatus will no longer function properly and the cutting unit will have to be replaced, usually by the user himself. In practice, however, the cutting units of different types of shaving apparatus nevertheless exhibit differences such that the cutting unit of one type of shaving apparatus must not be placed in a different type of shaving apparatus, for example because this may have an adverse effect as regards the functionality of the shaving apparatus.

For example, there are types of shaving apparatus which are washable, i.e. the shaving head can be rinsed out with water. Other types of shaving apparatus are not washable. The cutting elements of the washable shaving apparatuses are made of a material which allows them to come into contact with water. The cutting elements of the non-washable shaving apparatuses are made of a different material, frequently a more inexpensive material which is not water resistant. This means that cutting elements intended for non-washable shaving apparatuses are not suitable for use in shaving apparatuses of the washable type. Consequently, the user must be prevented from placing the wrong cutting elements in his shaving apparatus. The same situation occurs with shaving apparatuses in which additives, such as a shaving emulsion, are used. The cutting units of the various types of shaving apparatus not only differ as regards the washability thereof, but also as regards their resistance against shaving emulsions.

Another example in which the forming of incorrect cutting unit-shaving apparatus combinations must be prevented is the following: in order to achieve a satisfactory hair cutting action, the so-termed cutting gap between the co-operating cutting edges of the internal and external cutting elements must be as small as possible. In many types of shaving apparatus this is realized by using an axially spring-loaded internal cutting element. As a result, the internal cutting element abuts against the external cutting element while prestressing said external cutting element, i.e. the cutting edges of the internal cutting element are pressed against the cutting edges of the external cutting element with a specific force. This is necessary because the cutting forces that occur during the cutting of hairs are directed such that the co-operating cutting edges tend to be forced apart. The spring force prevents the gap between the cutting edges from becoming too large during cutting. However, said spring force also leads to a relatively great deal of friction between the co-operating cutting edges. In order to reduce said friction, it has been proposed in EP-B1-0 074 684 to provide the internal cutting element with an axial bearing surface, which co-operates with an axial bearing surface of the external cutting element. This achieves that the axial spring force is transferred to the external cutting element via said axial bearing services, so that a minimum cutting gap is realized. The friction losses are minimal, which is important in the case of rechargeable shaving apparatuses. Rechargeable shaving apparatuses fitted with such cutting units thus require less power than rechargeable shaving apparatuses fitted with cutting units the cutting elements of which make contact with each other via spring force. Thus there are high-power and low-power rechargeable shaving apparatuses. It is apparent that it is undesirable for cutting units intended for a high-power shaving apparatus to be fitted in a low-power shaving apparatus.

A third example in which the placing of incorrect cutting units in the shaving apparatus must be prevented concerns the shape of the external cutting element, in particular the annular wall portion thereof, in which the hair entry openings are present. There are types of shaving apparatus in which the wall portion provided with the hair entry openings is flat, and there are also types in which the wall portion is slightly curved (see EP-B1-0 652 086). The cutting edges of the internal cutting element are adapted to the shape of the external cutting element, i.e. an external cutting element comprising a curved wall portion as referred to above goes together with internal cutting elements having corresponding curved cutting edges. The same applies to cutting elements having flat wall portions. The external dimensions of the external cutting elements are such that said cutting elements fit into the holders of both types of shaving apparatus. When a user replaces one of the cutting units with a cutting unit of a different type of shaving apparatus, for example, this is not a problem in itself as long as the external cutting element and the internal cutting element of a cutting unit remain combined with each other. Upon cleaning of the cutting units, however, the internal cutting element and the external cutting element are taken apart, cleaned and put together again. If an internal cutting element associated with a slightly spherical external cutting element is placed in a flat external cutting element, or vice versa, major problems will arise. Such a situation must be prevented.

The object of the invention in relation to shaving apparatuses as referred to in the first paragraph is to prevent the possibility of cutting units intended for shaving apparatuses of a particular type being placed in shaving apparatuses of a different type.

The system according to the invention is to that end characterized in that the external cutting element of only one of the two types of shaving apparatus is provided with at least one recess, and in that the holder of the type of shaving apparatus in question is provided with at least one cam which corresponds to the recess of the external cutting element. A unique combination of cutting unit and holder can be obtained with such a combination of one or more cams and one or more recesses, i.e. a particular cutting unit can only be placed in a holder of a particular type of shaving apparatus. In this way, the occurrence of errors that may have adverse consequences is prevented.

The invention also relates to a cutting unit comprising an external cutting element formed by a circular cover provided with hair entry openings and an edge portion, and an internal cutting element comprising hair cutting means, which is rotatably driven relative to the external cutting element, for use in a shaving apparatus of the system as referred to above, in which said edge portion is provided with at least one recess.

The invention will now be explained in more detail by means of a few examples illustrated in drawings.

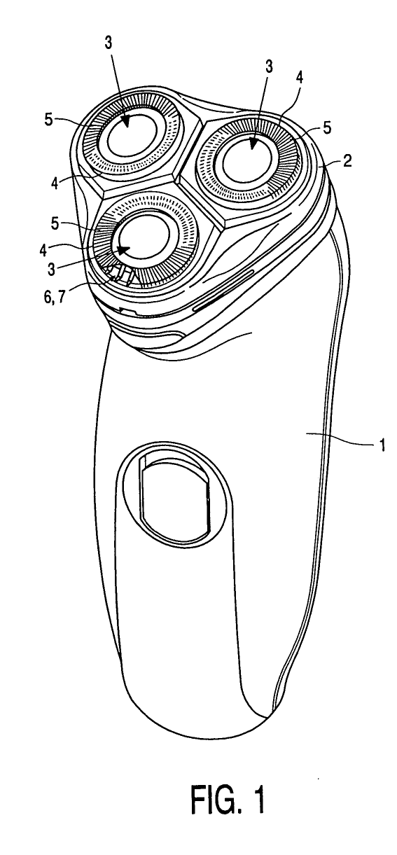

FIG. 1 shows a shaving apparatus comprising three cutting units,

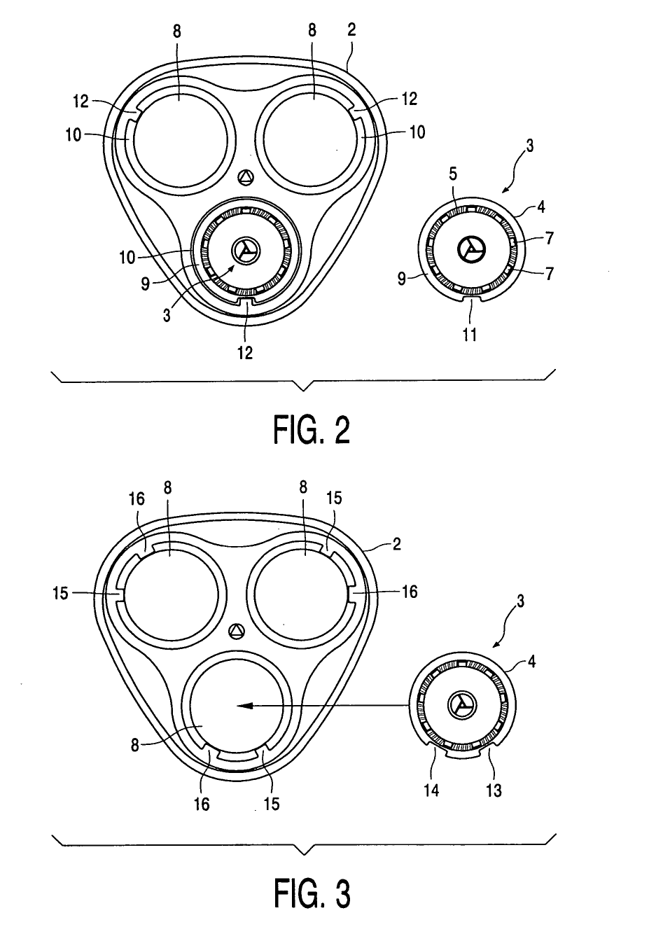

FIG. 2 is a bottom view of a shaving head holder with a cutting unit according to a first example, and

FIG. 3 is a bottom view of a shaving head holder with a cutting unit according to a second example.

FIG. 1 shows a rotary shaving apparatus comprising a housing 1 and a shaving head holder 2 that can be detached from the housing and/or is pivoted to the housing. Present in the shaving head holder are three cutting units 3, also called shaving heads, which each comprise an external cutting element 4 with hair entry apertures 5 and an internal cutting element 6 comprising cutting means 7, which is rotatably driven relative to the external cutting element. The internal cutting element is driven by a motor present in the housing (not shown).

As is shown in FIG. 2, the shaving head holder has three openings 8, into which a cutting unit 3 can be fitted. Each external cutting element 4 is formed by a circular cover in which the hair entry apertures 5 are present. In this example, said apertures are substantially radially extending slots. The cover has a flange-shaped edge portion 9. Each aperture 8 of the shaving head holder has a circular, inwardly extending edge portion 10. When a cutting unit is fitted in the opening 8, the edge portion 9 of the cover is supported on the edge portion 10 of the aperture. Each cutting unit is fixed in the shaving head holder by means not shown. According to the invention, each external cutting element (cover) is provided with at least one recess. In the example of FIG. 2, only one recess 11 is provided. Said recess is present in the flange-shaped edge portion 9. The shaving head holder 2 is provided with an inwardly extending cam 12 near each opening, which cam corresponds to the recess 11 of the external cutting element. When a cutting unit is fitted into an opening of the shaving head holder, this must be done in such a manner that the cam 12 slips into the recess. If a user should wish to fit a cutting unit not provided with such a recess into the opening, this will appear to be impossible. The cutting unit will not be positioned level in the shaving head holder, which will immediately be noticed by the user. In addition, the cutting unit cannot be properly locked in position in the shaving head holder with the fixing means, and consequently the shaving head holder cannot be properly mounted on the housing of the shaving apparatus, either. It will be understood that a combination of many recesses and cams is possible in order to obtain a unique situation. Variations as regards the number of cams and recesses and the dimensions and shapes thereof are possible.

FIG. 3 shows a second example. In this example, two recesses 13-14 are present in the external cutting element 4, which recesses moreover differ in size. The shaving head holder 2 is provided with two cams 15-16 corresponding to the recesses 13-14 at each opening 8. It will be understood that not only a cutting unit 3 not having a recess in its external cutting element 4 does not fit in the opening 8 of the shaving head holder 2 of FIG. 3, but that it is not possible to fit a cutting unit according to FIG. 2 in said opening either.

1. A system of two types of shaving apparatus, each having a housing on which a holder for at least one cutting unit can be mounted, which cutting unit comprises an external cutting element, which is formed by a circular cover provided with hair entry apertures, and an internal cutting element comprising hair cutting means, which is rotatably driven relative to the external cutting element, which holder is provided with an opening in which the cutting unit can be detachably mounted, characterized in that the external cutting element of only one of the two types of shaving apparatus is provided with at least one recess, and in that the holder of the type of shaving apparatus in question is provided with at least one cam which corresponds to the recess of the external cutting element.

2. A cutting unit comprising an external cutting element formed by a circular cover provided with hair entry openings and an edge portion, and an internal cutting element comprising hair cutting elements, which is rotatably driven relative to the external cutting element, for use in a shaving apparatus of the system as claimed in claim 1, characterized in that said edge portion is provided with at least one recess.
